(19) United States
(12) Patent Application Publication
(10) Pub. No.: US 2010/0116376 A1
(43) Pub. Date: May 13, 2010

(54) ANTI-TOMBSTONING LEAD FREE ALLOYS FOR SURFACE MOUNT REFLOW SOLDERING

(76) Inventors: Benlih Huang, Pleasanton, CA (US); Ning-Cheng Lee, New Hartford, NY (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/576,123

(22) Filed: Oct. 8, 2009

Related U.S. Application Data
(62) Division of application No. 10/935,118, filed on Sep. 8, 2004.

(51) Int. Cl. B23K 35/34; B23K 1/00

(52) U.S. Cl. 148/24

(57) ABSTRACT

A lead-free solder alloy composition comprising tin, silver and copper, and a process for reflow soldering for minimizing tombstoning frequency are disclosed. In one particular exemplary embodiment, the lead-free Sn—Ag—Cu solder alloys for minimizing the tombstoning effect of the present disclosure display high mass fraction during melting and prolonged melting as shown by a widened DSC peaks, that allows for a balanced surface tension on both ends of the chip component to develop. In accordance with further aspects of this exemplary embodiment, the alloys display a mass fraction of solid during melting greater than 20% and a DSC peak width greater than 8° C. using a 5° C./min scan rate. In accordance with further aspects of this exemplary embodiment, the alloy comprises on a weight basis Ag 1-4.5%, Cu 0.3-1% balanced with Sn.

### CROSS-REFERENCE TO RELATED APPLICATIONS

This patent application claims priority to U.S. Provisional Patent Application No. 60/517,404 (Attorney Docket No. 64470.000005); filed Nov. 6, 2003, which is hereby incorporated by reference herein in its entirety.

### FIELD OF THE DISCLOSURE

The present disclosure relates generally to lead free alloys for use in soldering and, more particularly, to anti-tombstoning alloy compositions comprising tin, silver and copper.

### BACKGROUND OF THE DISCLOSURE

As the electronics industries continue to pursue miniaturization of the electronic devices, increasing utilization of the small leadless components such as 0402 (this terminology means that the components are 40 mil×20 mil in size) and 0201 has resulted in a rapid increase in tombstoning defects. Such tombstoning defects, which are one of the most common defects observed in surface mount reflow soldering of small leadless components such as resistors and capacitors are caused by a tombstoning effect (also known as the Manhattan effect, Drawbridge effect, and Stonehenge effect). This is a phenomenon in which a chip component is detached from the printed circuit board at one end while remaining bonded to the circuit board at the other end, whereby the chip component rises up toward a vertical position.

The tombstoning effect is attributed to the imbalance of a pulling force caused by surface tension of molten solders at both ends of a component during reflow soldering. The intricate balance of the surface tension of the molten solder on the component may be easily disturbed by either the change of the solderability of the component or by differences in melting at the moment solder paste at each end of the component begins to reflow.

In order to overcome the tombstoning problem in electronics manufacturing, new alloy technologies have been developed as demonstrated by the teachings of Taguchi et al. (U.S. Pat. No. 6,050,480) and Huang et al. (U.S. Patent Application No. 20020063147). Taguchi et al. teaches using a solder powder alloy consisting of 60-65% tin (Sn), 0.1-0.6% silver (Ag), 0.1-2% antimony (Sb), and a balance of lead (Pb), to prevent tombstoning during reflow soldering. Taguchi essentially employs Ag and Sb to effectively increase the solidification temperature range and, in turn, to prevent tombstoning. Likewise, Huang et al. teaches using an anti-tombstoning solder comprising of 32.0-42.0% (Pb), 58.0-68.0% (Sn), and 0.1-0.7% (Ag) to provide a wider solidification range and balance the surface tension of the molten solder.

While these proposed solder alloys minimize tombstoning frequency, they contain lead. Lead is known to have toxic effects and poses environmental and public health risks. For this reason, federal legislation has imposed strict limitations upon the use of lead and lead-containing compositions. Therefore, in recent times, replacing the tin-lead containing solders with lead-free solders has become a global trend in the electronics industries. Among these promising lead-free alloys, the preferred lead-free solders are tin-silver-copper alloys. For example, the Japan Electronic Industry Development Association (JEIDA) has recommended using (4.0-2.0) % (Sn) (1.0-0.5) % (Ag) balanced with Cu. (“Challenges and efforts toward commercialization of lead-free solder road map 2000 for commercialization of lead-free solder—ver. 1.1”, The Japan electronic industry development association, lead-free soldering R&D project committee, February 2000, at http://www.jeida.or.jp/english/information/phfree/roadmap.html//). Further, the European IDEALS consortium has recommended using Sn95.5Ag3.8Cu0.7 (J. Bath, C. Hardwerker, and E. Bradley, “Research update: Lead-free solder alternatives”, Circuit Assembly, May 2000, pp 31-40). And, in the U.S., the Lead-free Assembly Project of National Electronics Manufacturing Initiative (NEMI) has recommended using Sn95.5Ag3.9Cu0.6 (Bath et al. supra).

In current electronics industries, the more commonly used Sn—Ag—Cu alloys consist of Ag (4.0-3.0) %, Cu (1-0.5) %, balanced with Sn, which are largely covered by the patents of Anderson et al. (U.S. Pat. No. 5,527,628) and Tanabe et al. (Japanese patent No. 05-050286), except the Sn95.5Ag4Cu0.5 alloy published by Beghardt et al. (E Berghardt and G. Petrow, “Ueber den Aufbau des Systems Silber-Kupfer-Zinn”, Zeitschrift fuer Metallkunde, 50, 1959, pp. 597-605) and the Castin alloy, Sn96.2Ag2.5Cu0.8Sb0.5, that has been disclosed in U.S. Pat. No. 5,405,577. In addition, S. K. Kang et al. (S. K. Kang et al., “Formation of Ag₃Sn plates in Sn—Ag—Cu alloys and optimization of their alloy composition”, 53^{rd} Electronic components and technology (ECTC) conference, 2003, pp. 64-76), have published results of their investigations on SnAg2.5Cu0.9 and SnAg2Cu0.9 alloys for electronic packages.

However, the main problem with the present state of the art in reflow soldering based on the lead-free Sn—Ag—Cu alloys is that usable anti-tombstoning solder alloys have not yet been discovered. Although Katoh et al. in U.S. Pat. No. 6,554,180 B1 teaches using “twin-peak” alloys with 0.2-1 mass % Ag, balanced with Sn as well as a flux to reduce the tombstoning defects, this alloy range deviates too much from the commonly acceptable Sn—Ag—Cu alloy compositions, and therefore is considered an impractical solution.

In view of the foregoing, it would be desirable to provide a lead-free alloy composition and process useful for soldering in the electronics industries, which overcomes the above-described inadequacies and shortcomings. More particularly, it would be desirable to provide novel lead-free Sn—Ag—Cu alloy compositions that are acceptable and usable for the process of reflow soldering in the assembly of electronic components that effectively minimizes tombstoning frequencies.

### SUMMARY OF THE DISCLOSURE

Lead-free Sn—Ag—Cu solder alloy compositions acceptable and usable in reflow soldering are disclosed. In one particular exemplary embodiment, a lead-free anti-tombstoning solder alloy comprises tin, silver and copper, which exhibits greater than 20% mass fraction of solid during melting.

In accordance with other aspects of this particular exemplary embodiment, the heat of absorption peak width, ΔT, during melting of the anti-tombstoning alloy is greater than 8° C. on a DSC (Differential Scanning Calorimetry) scan rate of 5° C./min.

In accordance with other aspects of this particular exemplary embodiment, the constituent metals comprise from about 1% to about 4.5% by weight of silver, from about 0.3% to 1% by weight of copper balanced with tin.

In accordance with other aspects of this particular exemplary embodiment, the constituent metals comprise from about 4% to about 2% by weight of silver, from about 0.5% to about 1% by weight of copper balanced with tin.

In accordance with other aspects of this particular exemplary embodiment, the constituent metals comprise from about 3.8% to about 2.5% by weight of silver, from about 0.5% to about 1% by weight of copper balanced with tin.

In accordance with other aspects of this particular exemplary embodiment, the alloy compositions may include a mechanical property improving element.

In accordance with other aspects of this particular exemplary embodiment, the mechanical property improving element comprises at least one or more element selected from the group consisting of Sb, Cu, Ni, Co, Fe, Mn, Cr and Mo in a total amount of at most 1 weight % of the solder alloy.

In accordance with other aspects of this particular exemplary embodiment, the alloy may include a melting temperature lowering element.

In accordance with other aspects of this particular exemplary embodiment, the temperature lowering element comprises at least one or more element selected from the group consisting Bi, In and Zn in a total amount of at most 3 weight % of the solder alloy.

In accordance with other aspects of this particular exemplary embodiment, the alloy may include an oxidation resistance improving element.

In accordance with other aspects of this particular exemplary embodiment, the oxidation resistance improving element comprises at least one or more element selected from the group consisting of P, Ga and Ge in a total amount of at most 0.5 weight % of the solder alloy.

A process of reflow soldering in electronic assemblies using various lead-free anti-tombstoning Sn—Ag—Cu solder alloy compositions is also disclosed. In one particular exemplary embodiment, the process of reducing tombstoning effect during reflow soldering in electronic assemblies comprises the usage of an anti-tombstoing solder in said assemblies, wherein said solder comprises 1% to about 4.5% by weight of silver, from about 0.3% to 1% by weight of copper balanced with tin.

In accordance with other aspects of this particular exemplary embodiment, the lead-free anti-tombstoning solder alloy comprises from about 4% to about 2% by weight of silver, from about 0.5% to about 1% by weight of Copper balanced with tin.

In accordance with other aspects of this particular exemplary embodiment, the lead-free anti-tombstoning solder alloy comprises from about 3.8% to about 2.5% by weight of silver, from about 0.5% to about 1% by weight of copper balanced with tin.

In accordance with other aspects of this particular exemplary embodiment, the lead-free anti-tombstoning alloy may include a mechanical property improving element.

In accordance with other aspects of this particular exemplary embodiment, the mechanical property improving element comprises at least or more element selected from the group consisting of Sb, Cu, Ni, Co, Fe, Mn, Cr and Mo in a total amount of at most 1 weight % of the solder alloy.

In accordance with other aspects of this particular exemplary embodiment, the led-free anti-tombstoning solder alloy may include a melting temperature lowering element.

In accordance with other aspects of this particular exemplary embodiment, the melting temperature lowering element comprises at least one or more element selected from the group consisting of Bi, In and Zn in a total amount of at most 3 weight % of the solder alloy.

In accordance with other aspects of this particular exemplary embodiment, the led-free anti-tombstoning alloy may include an oxidation resistance improving element.

In accordance with other aspects of this particular exemplary embodiment, the oxidation resistance improving element comprises at least one or more element selected from the group consisting of P, Ga and Ge in a total amount of at most 0.5 weight % of the solder alloy.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 is a DSC (differential scanning calorimetry) curve of the Sn95.5Ag3.8Cu0.7 alloy composition in accordance with an embodiment of the present disclosure.

FIG. 2 is a DSC curve of the Sn 95.5Ag3.5Cu1 alloy composition in accordance with an embodiment of the present disclosure.

FIG. 3 is a DSC curve of the Sn 95.5Ag3.8Cu0.7 alloy composition in accordance with an embodiment of the present disclosure.

FIG. 4 is a DSC curve of the Sn 96.7Ag2.5Cu0.8 alloy composition in accordance with an embodiment of the present disclosure.

FIG. 5 is a DSC curve of the Sn 97.5Ag2Cu0.5 alloy composition in accordance with an embodiment of the present disclosure.

FIG. 6 is a DSC curve of the Sn 98.3Ag0.96Cu0.74 alloy composition in accordance with an embodiment of the present disclosure.

FIG. 7 is a DSC curve of the Sn 96.5Ag3.5Cu1 with estimated mass fraction of 64% in accordance with an embodiment of the present disclosure.

FIG. 8 illustrates the bar chart of the tombstoning frequency of the various Sn—Ag—Cu alloy compositions of the present disclosure.

### DETAILED DESCRIPTION OF EXEMPLARY EMBODIMENT(S)

The present disclosure is directed toward lead-free anti-tombstoning solder alloys comprising tin, silver and copper which exhibit the following properties:

a) High mass fraction during melting as manifested in a slow melting and wetting behavior.
b) Prolonged melting as manifested by a widened DSC peak that allows a more balanced pulling force on both ends of a component to develop.

Among the Sn—Ag—Cu alloys, the more widely used lead-free solder alloys for reflow soldering have compositions such as Ag (4.0-2.0) %, Cu (1-0.5) %, balanced with Sn. But the more preferred compositions in the industry are Ag (4.0-3.0) %, Cu (1-0.5) %, balanced with Sn. Within this general Sn—Ag—Cu alloy composition range, solder alloy compositions were developed possessing the above cited properties for reducing the tombstoning frequency in accordance with the present disclosure.

As used herein, the term “lead free” means that the alloy or solder does not contain lead or is essentially free of lead. As a guideline to the meaning of “essentially free of lead,” see Federal Specification QQ-S571E Interim Amendment 5 (ER) 28 Dec. 1989, paragraph 3.2.1.1.1, as approved by the Commissioner, Federal supply service, General Services Administration (lead should not exceed 0.2%).

Melting behavior is closely related to the tombstoning frequency of Sn—Ag—Cu alloys in reflow soldering. Differential scanning calorimetry (DSC) was used to study the melting behavior of the various Sn—Ag—Cu alloy compositions of the present disclosure.

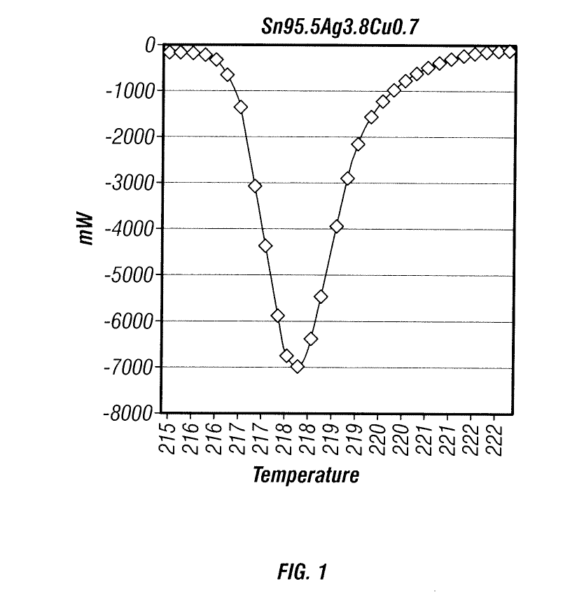

Referring now to FIGS. 1-6, there are shown the DSC curves of the various Sn—Ag—Cu alloy compositions in accordance with several embodiments of the present disclosure.

FIG. 1 is a DSC curve for a Sn95.5Ag3.8Cu0.7 lead free solder alloy. It begins melting at 217° C., a large peak of heat absorption (endothermic peak) appears at 219° C. and melting is entirely completed at 223° C.

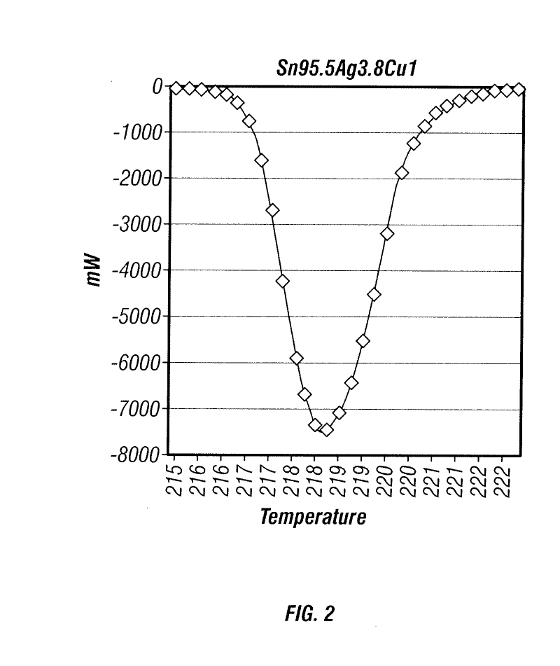

FIG. 2 is a DSC curve for a Sn95.5Ag3.5Cu1 lead free solder alloy. It begins melting at 217° C., a large peak of heat absorption appears at 218° C., and melting is entirely completed at 222° C.

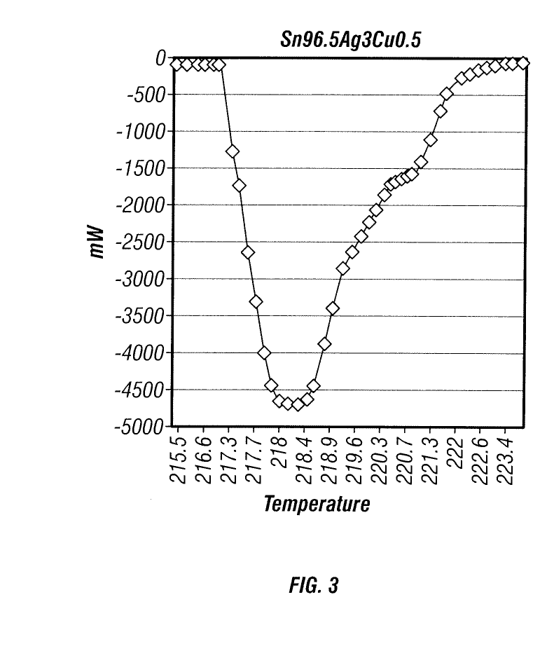

FIG. 3 is a DSC curve for a Sn96.5Ag3Cu0.5 lead free solder alloy. It begins melting at 217° C., a large peak of heat absorption appears at 218.6° C., a second shoulder peak appears at 221° C., and melting is entirely completed at 223.5° C.

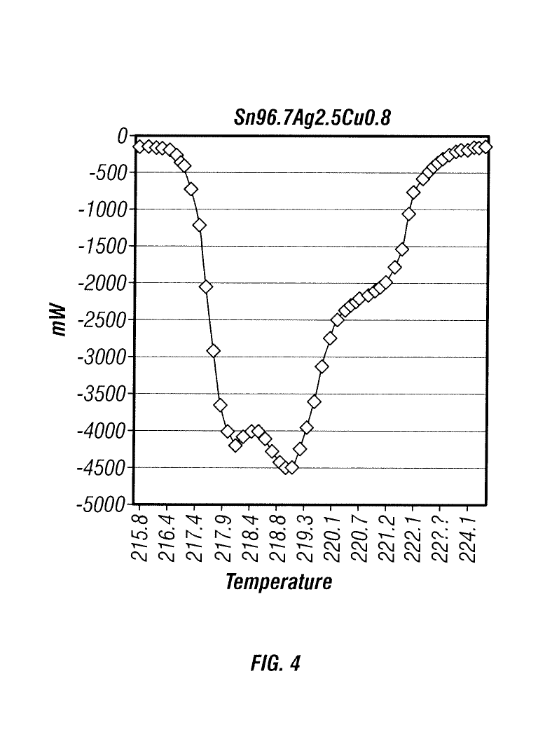

FIG. 4 is a DSC curve for a Sn96.7Ag2.5Cu0.8 lead free solder alloy. It begins melting at 216.5° C., a large peak of heat absorption appears at 219.5° C., and a shoulder absorption peak appears at 221.2° C., and melting is completed at 225° C.

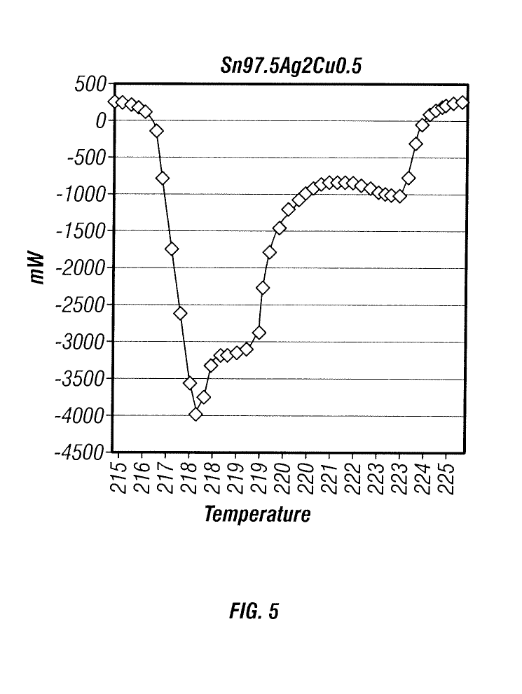

FIG. 5 is a DSC curve for a Sn97.5Ag2Cu0.5 lead free solder alloy. It begins melting at 216.5° C., a first large peak of heat absorption appears at 218.2° C., a second large peak of heat absorption occurs at 219.5° C., and a small peak appears at 223.5° C., and melting is completed at 225° C.

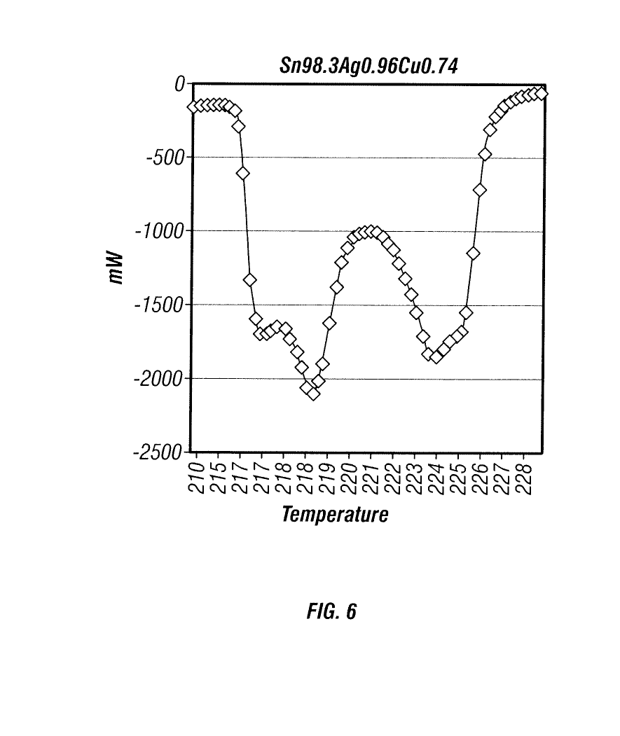

FIG. 6 is a DSC curve for a Sn98.3Ag0.96Cu0.74 lead free solder alloy. It begins melting at 216° C., a large peak of heat absorption appears at 217.7° C., a second large peak appears at 218.8° C., a third large peak appears at 224.5° C., a shoulder peak appears at 225.4° C., and melting is completed at 228° C.

FIGS. 1-2 represent single peak alloys with one peak of heat absorption in a DSC curve between its solidus and liquidus temperatures. FIG. 3 represents a “twin-peak” alloy with two peaks of heat absorption in a DSC curve between its solidus and liquidus temperatures with the first peak being greater in magnitude than the second peak. The major portion of the melting occurs at the first peak. FIG. 4 represents a “multiple-peak”alloy with three peaks of heat absorption in a DSC curve between its solidus and liquidus temperatures, with the first two peaks being about equal in magnitude, and the major portion of the melting occurring at these first two peaks. FIG. 5 represents a multiple peak alloy with three peaks of heat absorption in a DSC curve between its solidus and liquidus temperatures, with the first two peaks being greater in magnitude than the second and third peaks, occurring at the start of melting; and the major portion of the melting occurring at the first two peaks. FIG. 6 represents a multiple peak alloy with four peaks of heat absorption in a DSC curve between its solidus and liquidus temperatures, with the first two peaks being about equal in magnitude with the third and the fourth peaks. About half of the melting occurs at the first two peaks and the other half occurs at the third and fourth peaks. As evidenced by these DSC curves, the alloy compositions of FIGS. 3-6 display a gradual and slow melting pattern that is characteristic of the anti-tombstoning effect.

Although the melting behavior associated with a high mass fraction at onset of melting generally appears more prevalent in an alloy with multiple endothermic peaks in a DSC scan, the principle also applies to single endothermic peak as well. The mass fraction can be obtained using a symmetry method, with the mirror plane passing through the peak of the first large endothermic peak. The symmetrical peak represents an idealized melting behavior of an eutectic alloy, where the residual area can be considered a solidus state.

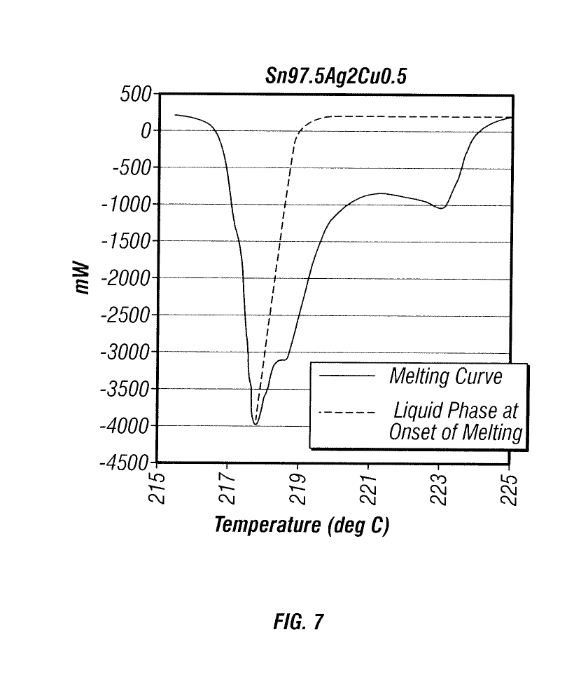

FIG. 7 illustrates a DSC curve for a Sn—Ag—Cu alloy composition as represented in FIG. 4 with a symmetrical peak fit to the first endothermic peak. From this symmetrical fit, the mass fraction of the Sn96.5Ag3Cu0.5 alloy composition was estimated to be 64% as shown in FIG. 7. It should be noted that a material with single melting point, such as pure indium metal, exhibits a symmetrical endothermic peak.

Invoking the aforementioned symmetry method for obtaining the mass fraction of solid, the DSC thermograms were analyzed based on the following approximations:

a) The DSC thermogram of a pure element or eutectic material could be represented by a symmetrical endothermic peak when the heating scanning rate is low.

b) All material exhibits comparable specific heat capacity.

Based on these approximations, a symmetrical virtual endotherm peak could be constructed on the low temperature end, with the first peak on the left of the DSC endotherm being the peak of the symmetrical endotherm.

The mass fractions of the various Sn—Ag—Cu alloy compositions of the present disclosure and their tombstoning performance are provided in table I.

TABLE I

| | | Normalized |
|---|---|---|
| | Mass Fraction | Tombstoning |
| Alloys | of Solid | Frequency |
| Sn98.3Ag0.96Cu0.74 | 80% | 11% |
| Sn97.5Ag2Cu0.5 | 64% | 10.3% |
| Sn96.7Ag2.5Cu0.8 | 65.8% | 10.3% |
| Sn96.5Ag3Cu0.5 | 51.6% | 48.6% |
| Sn95.5Ag3.5Cu1 | 4.7% | 300% |
| Sn95.5Ag3.8Cu0.7 | 15.3% | 100% |

These results clearly indicate that the mass fraction of solid during melting closely relates to the tombstoning frequency. In principle, a pasty solder with a large mass fraction of solid exhibits a slow wetting at the onset of the melting, and consequently is able to develop a significantly more balanced wetting force. Accordingly, the greater the mass fraction of the solid at the onset of the melting, the more sluggish the wetting will be, and the lower the tombstoning frequency will be.

As used herein the term “DSC width”, or A T, represents a difference between the onset and the end temperature of the melting peak of the heating endotherms of Sn—Ag—Cu alloys, using a Sn63Pb37 alloy for comparison. The width of a DSC peak often reflects the mass fraction of solid at the onset of melting. The results of heat absorption, the DSC width (ΔT), and the normalized tombstoning frequency for the various Sn—Ag—Cu alloy compositions of the present disclosure are provided in Table 2.

TABLE 2

| | | | | |
|---|---|---|---|---|
| | | | | Normalized |
| | Onset | End | ΔT | Tombstoning |
| Alloy | (° C.) | (° C.) | (° C.) | Frequency |

| | | | | |
|---|---|---|---|---|
| Sn95Ag4.5Cu0.5 | 217 | 222 | 5 | 132% |
| Sn95.5Ag4Cu0.5 | 217 | 222 | 5 | 113% |
| 95.5Sn3.8Ag0.7Cu | 217 | 223 | 6 | 100% |
| 95.5Sn3.5Ag1Cu | 217 | 222 | 5 | 300% |
| 96.5Sn3Ag0.5Cu | 217 | 223.5 | 6.5 | 48.6% |
| Sn97.6Ag2.7Cu0.5 | 216.5 | 223 | 7 | 24.5% |
| 96.7Sn2.5Ag0.8Cu | 216.5 | 224 | 7.5 | 10.3% |
| 97.5Sn2Ag0.5Cu | 216.5 | 225 | 8.5 | 10.3% |
| 98.3Sn0.96Ag0.74Cu | 216 | 228 | 12 | 11% |

As evident from the above results, the width of the DSC peak (ΔT) was found to correlate directly with the tombstoning frequency. Generally, it was found that the mass fraction of solder alloys at the onset of solder melting gradually increases with decreasing Ag concentration in Sn—Ag—Cu alloys. Further, it was found that multiple endothermic peaks gradually appeared as the concentration of Ag decreased in the Sn—Ag—Cu alloys. In view of the above results that shows a dependence of the tombstoning frequency on the width of the DSC peak (ΔT) and the mass fraction of solid, the present disclosure is directed to compositions of Sn—Ag—Cu with substantially reduced tombstoning frequency.

A single narrow endothermic peak corresponds to a rapid melting of the solder. In the presence of a temperature gradient across a component, the solder paste at one end of the component melts while the other end does not. The wetting force of the molten solder is greater than the adhesion between an un-melted solder paste to the component, and therefore causes tombstoning. However, a broad single peak, or a twin, or multiple endothermic peaks in the DSC curve indicates the presence of solid phase at onset of melting. This presence of solid phase results in a sluggish wetting leading to a more balanced wetting force at both ends of the component, and consequently to a lower tombstoning frequency.

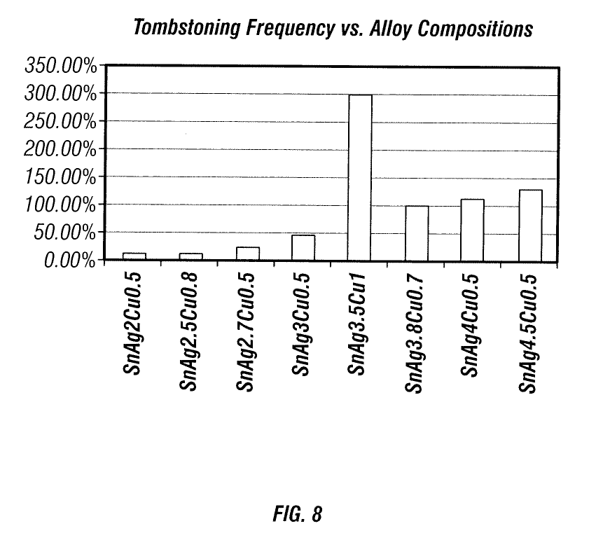

FIG. 8 illustrates the bar chart of the tombstoning frequency of the various Sn—Ag—Cu alloy compositions of the present disclosure. The tombstoning results of the Sn—Ag—Cu alloys were normalized with respect to Sn95.5Ag3.8Cu0.7, which was one of the most widely used lead-free solder compositions, and was used as a standard in the test. As evident from FIG. 8, the composition Ag 3.5, Cu (1-0.5) %, balanced with Sn, or more specifically the Sn95.5Ag3.5Cu1, which is considered closest to the true eutectic point of the Sn—Ag—Cu alloys (Ursula R. Kattner, “Phase diagrams for Lead-free Solder Alloys” JOM, 2002, pp 45-50), shows the fasted melting rate. Accordingly, the tombstoning frequency of this alloy is the greatest of all the alloys of the present disclosure. All the off-eutectic alloys, particularly the compositions with (Ag<3.5) %, Cu (1-0.5) %, balanced with Sn, show lower tombstoning frequency.

It is particularly noteworthy that the Sn97.6Ag2Cu0.5 alloy composition exhibited improved tombstoning result, which is in contrast with the claim made by Katoh (U.S. Pat. No. 6,554,180 B1). According to Katoh's prediction, the Sn97.5Ag2Cu0.5 alloy composition would be expected to show a tombstoning effect because he states that in order to minimize the tombstoning defect, the first peak of the twin peak alloy should not be much larger than the second peak of the “twin-peak” alloy. Thus, this anti-tombstoning behavior of Sn97.6Ag2Cu0.5 alloy in this disclosure can only be explained by the mechanism of mass fraction of solid at onset of melting of solder.

Although the main embodiment of the present disclosure comprises various Sn—Ag—Cu alloy compositions, these alloys may also be modified to improve the physical and mechanical properties, including the oxidation resistance. For example, the elements that improve strength consist of Sb, Cu, Ni, Co, Fe, Mn, Cr and Mo.

According to another embodiment of the disclosure, the Sn—Ag—Cu alloys could be modified to improve the mechanical properties without sacrificing the anti-tombstoning effect with one or combinations of the following elements: Sb, Cu, Ni, Co, Fe, Mn, Cr, and Mo. In order to prevent potential adverse effects due to doping, the preferred concentration of the doping agent overall is not to exceed 1 weight % of the solder alloy.

According to another embodiment of the present disclosure, the melting temperature of the Sn—Ag—Cu could be lowered by adding elements such as Bi, In, and Zn. The preferred concentrations of the overall additions of either one or a combination of these elements are no greater than 3 weight % of the solder alloy.

According to another embodiment of the present disclosure, the Sn—Ag—Cu alloys may also modified by adding oxidation resistant elements such as P, Ga, and Ge. Because the melting temperature of the Sn—Ag—Cu alloys could be undesirably increased if the concentration of the aforementioned elements are too high, the overall maximum concentration of one or a combination of P, Ga, and Ge should be 0.5 weight % of the solder alloy.

### EXAMPLES

The following examples present illustrative but non-limiting embodiments of the present disclosure.

### Example 1

### Making a Solder

Soldering is an operation in which metallic parts are joined by a molten solder alloy whose melting temperature is generally below 450° C. There are many varieties of solder alloys based on tin and lead, but most recently, due to concerns about environmental and safety issues, Sn—Ag—Cu alloys have been widely used in soldering for electronics assembly. The technique of making solder paste is to mix solder powder with flux. First, the solder alloys are produced by melting ingredient metal ingots and mixing them into solder alloys. Then, the alloys are further atomized to solder powder by either a gas atomization or centrifugal atomization.

### Example 2

### Soldering of Components

Soldering using a solder paste is called reflow soldering, which is considered the most widely employed soldering method in current electronic industries. There are generally four steps of reflow soldering. First, the solder paste (which is used to remove the metal oxide, thus allowing the solder to react with the pieces being joined; the solder paste is generally composed of metal powder plus flux or a reducing agent) is printed onto pads on a print circuit board. Second, a component is placed on the solder paste deposits. Third, the solder paste is heated above the melting temperature of the constituent solder alloy, and thus produces molten solder between the component and the pads. Finally, as the molten solders is cooled, solder joints are formed.

### Example 3

### Tombstoning Test of Solder Pastes

A tombstoning test may be performed using an exaggerated severe soldering condition to produce tombstoning. The conditions are shown as follows:

(a) A 0.25 mm thick stencil is used to produce a thick deposit of solder paste. When a small component is soldered to a pad with a thick deposit of solder, the frequency of tombstoning has been found to be greater.

(b) A vapor phase reflow oven is employed. The oven is full of vapor generated by heating a high boiling point fluid such as freon with coils at the bottom of the oven. As the printed circuit board is placed in the vapor, the solder paste is heated by the hot vapor and results in soldering of the components. Following the removal of the reflowed board, the tombstoned components are counted and the percentage of tombstones with respect to the number of components is used for comparison.

(c) A 20 cm×15.2 cm board with Cu pads is employed for testing the tombstoning effect. Four identical patterns with various pad sizes and spacings are on the tombstoning board, and these patterns are divided into two pairs of patterns in mirror image with each other to reduce the possible reflow differences. In one particular test, 169 of 0402 chips were placed on each pair of patterns, of which one pair of patterns was used as the control paste and the other as the target paste. To further reduce the possible performance difference due to printing, the pastes were printed alternately on these two pair of patterns. Altogether, there were 10 boards or 1352 chips soldered for each paste. It is noteworthy that the reflow condition was stable and the tombstoning results were very consistent, and therefore the tombstoning performance of the pastes could be compared even without being normalized with respect to the control.

### Example 4

### The Tombstoning Frequency

The tombstoning results were generated using Sn97.5Ag2Cu0.5, Sn96.7Ag2.5Cu0.8, Sn96.5Ag3Cu0.5, Sn96Ag3Cu1, and Sn95.5Ag3.8Cu0.7 pastes, which consist of the respective alloy powders with a rosin-based mildly activated flux (e.g., 60% rosin, 5% dimethylamine hydrochloride, 15% glycerol, 20% rheological and other minor components). The tombstoning frequency is illustrated in Table 3.

TABLE 3

| Sn95.5Ag3.8Cu0.7 | Sn96.5Ag3.5Cu1 | Sn95.5Ag3Cu0.5 | Sn96.7Ag2.5Cu0.8 | Sn97.5Ag2Cu0.5 |
|---|---|---|---|---|
| 2.14% | 6.4% | 1.04% | 0.22% | 0.22% |

These results clearly show that the near eutectic Sn95.5Ag3.5Cu1 alloy composition has the greatest tombstoning frequency, and the tombstoning frequency decreases with decreasing Ag concentration in Sn—Ag—Cu alloy. The lowest tombstoning frequency is achieved with Ag concentration at 2.5-2.0%. The alloy compositions with lower tombstoning frequency were identified to have greater mass of solid, greater DSC peak width, and higher surface tension.

However, as anyone who is skilled in the art could envisage, the same criteria as used for Sn—Ag—Cu alloys herein may be applicable to alloys consisting of Sn—Ag and Sn—Cu alloys, which may be modified with dopants to improve their physical and mechanical properties, including oxidation resistance. The elements for improving mechanical properties, for example, may consist of one or combinations of the following elements: Sb, Cu, Ni, Co, Fe, Mn, Cr, and Mo. Further, elements used for improving the oxidation resistance may, for example, consist of P, Ga, and Ge. Additionally, elements used for lowering the melting temperature of the alloys may, for example, consist of Bi, In, and Zn.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the following appended claims. Further, although the present disclosure has been described herein in the context of a particular implementation in a particular environment for a particular purpose, those of ordinary skill in the art will recognize that its usefulness is not limited thereto and that the present disclosure can be beneficially implemented in any number of environments for any number of purposes. Accordingly, the claims set forth below should be construed in view of the full breadth and spirit of the present disclosure as described herein.

1. A solder alloy paste consisting essentially of a flux and a single solder alloy powder consisting essentially of from 96.5% to 98.3% by weight tin, from 2.0% to 2.7% by weight silver, and from 0.5% to 0.8% by weight copper which exhibits greater than 20% mass fraction of solid during the onset of melting, and exhibits less than 50% tombstoning frequency.

2. The solder alloy paste of claim 1, wherein the silver in the single solder alloy powder consists of from 2.0% to 2.5% by weight.

3. The solder alloy paste as in claim 1 or 2, wherein the single solder alloy paste includes an oxidation resistance improving element.

4. The solder alloy paste as in claim 1 or 2, wherein the single solder alloy powder includes a mechanical property improving element.

5. The solder alloy paste of claim 4, wherein the mechanical property improving element comprises at least one or more elements selected from the group consisting of Sb, Ni, Co, Fe, Mn, Cr, and Mo in a total amount of at most 1 weight % of the single solder alloy powder.

6. A process of reducing tombstoning effect during reflow soldering in electronic assemblies comprising using a solder alloy paste during reflow soldering of the electronic assemblies, wherein the solder alloy paste consists essentially of a flux and a single solder alloy powder consisting essentially of from 96.5% to 98.3% by weight tin, from 2.0 to 2.7% by weight silver, and from 0.5% to 0.8% by weight copper, wherein the alloy exhibits greater than 20% mass fraction of solid during the onset of melting and exhibits less than 50% tombstoning frequency.

7. The process of claim 6, wherein the silver in the single solder alloy powder consists of from 2.0% to 2.5% by weight.

8. The process as in claim 6 or 7, wherein the single solder alloy powder includes a mechanical property improving element.

9. The process of claim 8, wherein the mechanical property improving element comprises at least one or more elements selected from the group consisting of Sb, Ni, Co, Fe, Mn, Cr, and Mo in a total amount of at most 1 weight % of the alloy.

10. The process as in claim 6 or 7, wherein the single solder alloy powder includes an oxidation resistance improving element.

11. The process of claim 10, wherein the oxidation resistance improving element comprises at least one or more elements selected from the group consisting of P, Ga, and Ge in a total amount of at most 0.5 weight % of the alloy.

12. The solder alloy paste of claim 3, wherein the oxidation resistance improving element comprises at least one or more elements selected from the group consisting of P, Ga, and Ge in a total amount of at most 0.5 weight % of the alloy.
